(19) United States
(12) Patent Application Publication
(10) Pub. No.: US 2015/0177575 A1
(43) Pub. Date: Jun. 25, 2015

(54) LIQUID CRYSTAL DISPLAY

(71) Applicant: Samsung Display Co., Ltd., Yongin-City (KR)

(72) Inventors: Soon Joon RHO, Suwon-si (KR); Hye Lim JANG, Hwaseong-si (KR); Kyung Min KIM, Seoul (KR); Jin-Lak KIM, Osan-si (KR)

(21) Appl. No.: 14/541,293

(22) Filed: Nov. 14, 2014

(30) Foreign Application Priority Data
Dec. 24, 2013 (KR) 10-2013-0162973

(51) Int. Cl. G02F 1/1343; G02F 1/137; G02F 1/1333; G02F 1/1368; G02F 1/1362

(52) U.S. Cl. CPC G02F 1/134309; G02F 1/1368; G02F 1/136286; G02F 1/136227; G02F 1/133345; G02F 1/137; G02F 2001/134345; G02F 2001/13712

(57) ABSTRACT

A liquid crystal display includes a first substrate, a first subpixel electrode is disposed on the first substrate and has a planar shape and, an insulating layer disposed on the first subpixel electrode, a second subpixel electrode which is disposed on the insulating layer, overlaps the first subpixel electrode, and includes a plurality of branch electrodes, a second substrate facing the first substrate, a common electrode disposed on the second substrate, and a liquid crystal layer injected between the first substrate and the second substrate, where the first subpixel electrode and the second subpixel electrode are applied with voltages of the same magnitude, and dielectric anisotropy of the liquid crystal layer is about −2.0 to about −2.7 at a temperature of about 30 degrees Celsius.

This application claims priority to and the benefit of Korean Patent Application No. 10-2013-0162973 filed on Dec. 24, 2013, and all the benefits accruing therefrom under 35 U.S.C. §119, the entire contents of which are incorporated herein by reference.

### BACKGROUND

(a) Field

The invention relates to a liquid crystal display.

(b) Description of the Related Art

A liquid crystal display (“LCD”) is one of flat panel display devices that are widely used and generally includes two display panels where a field generating electrode such as a pixel electrode and a common electrode is formed, and a liquid crystal (“LC”) layer interposed therebetween.

The LCD generates an electric field in a LC layer by applying voltage to the field generating electrode, to determine orientations of LC molecules of the LC layer and control polarization of incident light, thereby displaying an image.

The LCD also includes switching elements connected to the respective pixel electrodes, and a plurality of signal lines such as gate lines and data lines for controlling the switching elements and applying voltages to the pixel electrodes.

Among the LCDs, a vertical alignment (“VA”) mode LCD, which aligns LC molecules such that the long axes thereof are perpendicular to the panels in the absence of an electric field, is spotlighted because of its high contrast ratio and wide reference viewing angle. A reference viewing angle is defined as a viewing angle that makes the contrast ratio equal to 1:10 or as a limit angle for inversion in luminance between the grays.

A method of realizing a wide viewing angle by defining a plurality of slits in the pixel electrode of this LCD to have a plurality of branch electrodes has been proposed.

### SUMMARY

When a plurality of slits is defined in the pixel electrode, a transmittance is deteriorated in a portion where the plurality of slit is defined, and response speed of the LCD becomes slow.

The invention provides a liquid crystal display (“LCD”) effectively preventing transmittance from being deteriorated or a response speed from being slow while defining a plurality of slits in a pixel electrode.

An LCD according to an exemplary embodiment of the invention includes a first substrate, a first subpixel electrode disposed on the first substrate, an insulating layer disposed on the first subpixel electrode, a second subpixel electrode disposed on the insulating layer and overlapping the first subpixel electrode, a second substrate facing the first substrate, a common electrode disposed on the second substrate, and a liquid crystal (“LC”) layer injected between the first substrate and the second substrate, where the first subpixel electrode and the second subpixel electrode are applied with voltages of the same magnitude, the second subpixel electrode includes a plurality of branch electrodes, the first subpixel electrode has a planar shape, and dielectric anisotropy of the LC layer is about −2.0 to about −2.7 at a temperature of about 30 degrees Celsius (° C.).

An interval between two adjacent branch electrodes among the plurality of branch electrodes may be equal to or greater than a width of a branch electrode of the plurality of branch electrodes.

The width of the branch electrode of the plurality of branch electrodes may be about 2 micrometers (μm) to about 3 μm, and the interval between two adjacent branch electrodes among the plurality of branch electrodes may be about 3 μm to about 4 μm.

A cell interval of the LC layer may be about 2.6 μm to about 3 μm.

The first subpixel electrode and the second subpixel electrode may be connected to each other through a contact hole defined in the insulating layer.

The LCD may further include a gate line and a data line disposed on the first insulation substrate, and a thin film transistor (“TFT”) connected to the gate line and the data line, where at least one of the first subpixel electrode and the second subpixel electrode is connected to a drain electrode of the thin film transistor.

An LCD according to another exemplary embodiment of the invention includes a first substrate, a first subpixel electrode disposed on the first substrate, an insulating layer disposed on the first subpixel electrode, a second subpixel electrode disposed on the insulating layer and overlapping the first subpixel electrode, a second substrate facing the first substrate, a common electrode disposed on the second substrate, and an LC layer injected between the first substrate and the second substrate, where the first subpixel electrode and the second subpixel electrode are applied with voltages of the same magnitude, the second subpixel electrode includes a plurality of branch electrodes, the first subpixel electrode has a planar shape, and an interval between two adjacent branch electrodes among the plurality of branch electrodes is equal to or greater than a width of a branch electrode of the plurality of branch electrodes.

An LCD according to another exemplary embodiment of the invention includes a first substrate, a first subpixel electrode disposed on the first substrate, an insulating layer disposed on the first subpixel electrode, a second subpixel electrode disposed on the insulating layer and overlapping the first subpixel electrode, a second substrate facing the first substrate, a common electrode disposed on the second substrate, and an LC layer injected between the first substrate and the second substrate, where the first subpixel electrode and the second subpixel electrode are applied with voltages of the same magnitude, the second subpixel electrode includes a plurality of branch electrodes, the first subpixel electrode has a planar shape, and a cell interval of the LC layer is about 2.6 μm to about 3 μm.

According to the LCD according to an exemplary embodiment of the invention, while defining a plurality of slits in the pixel electrode, deterioration of transmittance and a slow response speed of the LCD may be effectively prevented.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 is a schematic cross-sectional view of an exemplary embodiment of a liquid crystal display (“LCD”) according to the invention.

FIG. 2 is a plan view of an exemplary embodiment of a LCD according to the invention.

FIG. 3 is a cross-sectional view of the LCD of FIG. 2 taken along line III-III.

FIG. 4 is a cross-sectional view of the LCD of FIG. 2 taken along line IV-IV.

FIG. 5 is a schematic view to explain a magnitude of an electric field applied to an exemplary embodiment of a liquid crystal (“LC”) layer of one pixel area of a LCD according to the invention.

FIG. 6 is a schematic view to explain a magnitude of an electric field applied to a LC layer of one pixel area of a conventional LCD.

FIG. 7 is a plan view of another exemplary embodiment of a LCD according to the invention.

FIG. 8 is a cross-sectional view of the LCD of FIG. 7 taken along line VIII-VIII.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

In the drawings, the thicknesses of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

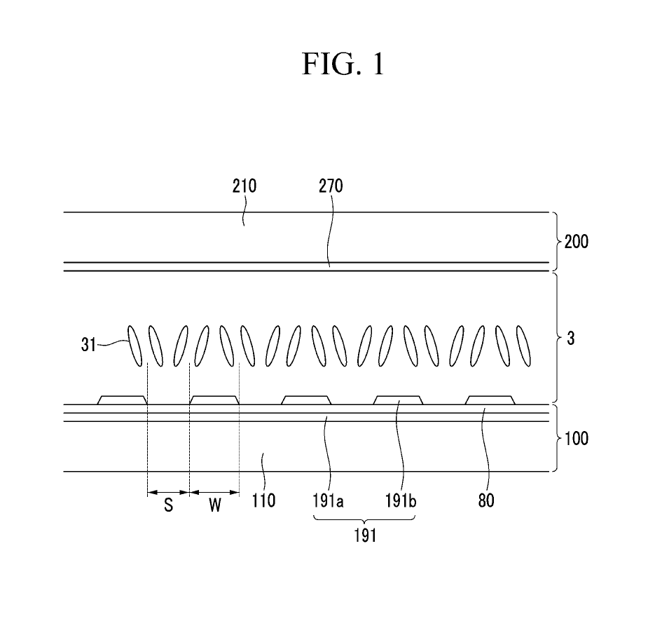

Hereinafter, a liquid crystal display (“LCD”) according to an exemplary embodiment of the invention will be described with reference to FIG. 1. FIG. 1 is a schematic cross-sectional view of a LCD according to an exemplary embodiment of the invention.

Referring to FIG. 1, a LCD according to an exemplary embodiment of the invention includes a first display panel 100 and a second display panel 200 facing each other, and a liquid crystal (“LC”) layer 3 inserted between the first display panel 100 and the second display panel 200.

The first display panel 100 includes a first subpixel electrode 191a disposed on a first substrate 110, an insulating layer 80 disposed on the first subpixel electrode 191a, and a second subpixel electrode 191b disposed on the insulating layer 80.

The first subpixel electrode 191a has a planar shape disposed on the entire pixel area. A plurality of cutouts is defined in the second subpixel electrode 191b, and a plurality of branch electrodes are defined by the plurality of cutouts.

An interval S between two adjacent branch electrodes among the plurality of branch electrodes is equal to or larger than a width W of the plurality of branch electrodes, and in detail, the width W of the plurality of branch electrodes is about 2 micrometers (μm) to about 3 μm, and the interval S between two adjacent branch electrodes among the plurality of branch electrodes is about 3 μm to about 4 μm.

The second display panel 200 includes a common electrode 270 disposed on a second substrate 210.

The LC layer 3 includes a plurality of LC molecules 31, and the plurality of LC molecule 31 are arranged such that they are aligned in a direction approximately perpendicular to the surface of the first substrate 110 and the second substrate 210 when the electric field is not applied.

Dielectric anisotropy Δ∈ of the LC layer 3 has a value of about −2.0 to about −2.7 at about 30 degrees Celsius (° C.).

A thickness of the LC layer 3, that is, a cell gap representing an interval between the first display panel 100 and the second display panel 200, is about 2.6 μm to about 3 μm.

In an exemplary embodiment, the LC layer 3 may include a prepolymer such as a monomer hardened through a polymer reaction by a light. The prepolymer may include a reactive mesogen polymerized by the light such as ultraviolet (“UV”) rays. A ratio of the prepolymer in the LC layer 3 may be about 0.1 percent (%) to about 1.0%.

In this way, a pixel electrode 191 of the LCD according to an exemplary embodiment of the invention includes the first subpixel electrode 191a with the planar shape and the second subpixel electrode 191b including a plurality of branch electrode, and the first subpixel electrode 191a and the second subpixel electrode 191b overlap each other. As described above, by providing the pixel electrode 191 to include the first subpixel electrode 191a with the planar shape and the second subpixel electrode 191b of a plurality of branch electrodes and providing the first subpixel electrode 191a and the second subpixel electrode 191b to overlap each other, the electric field is generated between the first subpixel electrode 191a and the common electrode 270 through the cutouts defined between the plurality of branch electrodes of the second subpixel electrode 191b. Accordingly, intensity of the electric field of the LCD is increased, and particularly, the electric field may also be generated in the region overlapping the cutouts defined between the plurality of branch electrodes. Accordingly, transmittance of the LCD may be increased.

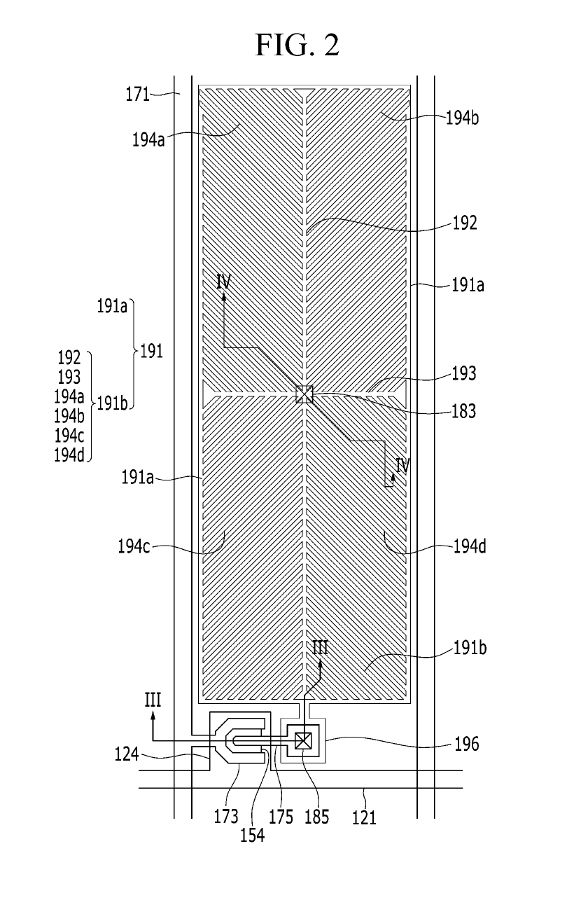

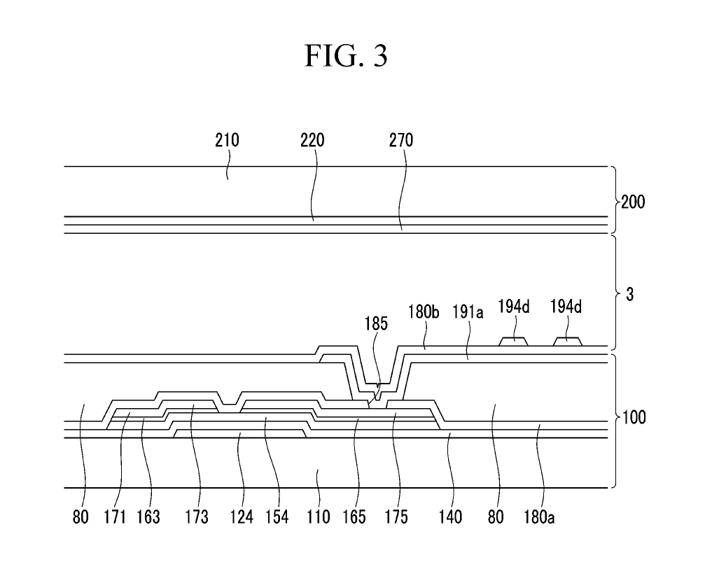

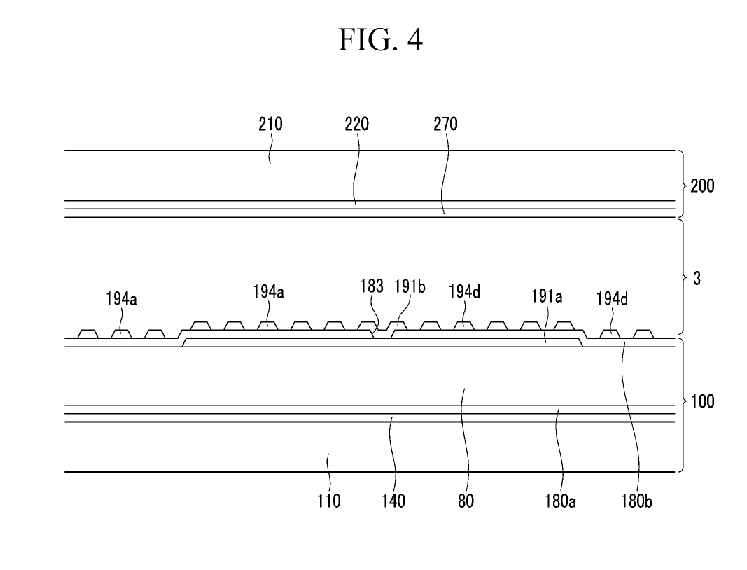

Next, a detailed structure of an LCD according to an exemplary embodiment of the invention will be described with reference to FIGS. 2 to 4. FIG. 2 is a plan view of an LCD according to an exemplary embodiment of the invention, FIG. 3 is a cross-sectional view of the LCD of FIG. 2 taken along line III-III, and FIG. 4 is a cross-sectional view of the LCD of FIG. 2 taken along line IV-IV.

Referring to FIGS. 2 to 4, the LCD according to an exemplary embodiment of the invention includes the first display panel 100 and the second display panel 200 facing each other, and the LC layer 3 inserted between the first display panel 100 and the second display panel 200.

Firstly, the first display panel 100 will be described.

A gate line 121 is disposed on the first substrate 110 including transparent glass, plastic, or the like.

The gate line 121 includes a gate electrode 124 and a wide end portion (not illustrated) for a connection with another layer or an external driving circuit.

Although not shown, a storage voltage line including the same layer as the gate line 121 may be further included.

A gate insulating layer 140 is disposed on the gate line 121.

A semiconductor 154 including amorphous or crystalline silicon is disposed on the gate insulating layer 140. In an exemplary embodiment, the semiconductor 154 may include an oxide semiconductor, for example.

A plurality of ohmic contacts 163 and 165 is disposed on the semiconductor 154. When the semiconductor 154 includes the oxide semiconductor, the ohmic contact may be omitted.

A data line 171 and a drain electrode 175 are disposed on the ohmic contacts 163 and 165 and the gate insulating layer 140.

The data line 171 includes a source electrode 173 and a wide end portion (not illustrated) for connection with another layer or an external driving circuit.

The gate electrode 124, the source electrode 173, and the drain electrode 175 provide a thin film transistor (“TFT”) along with the semiconductor 154, and a channel of the TFT is provided in the semiconductor 154 between the source electrode 173 and the drain electrode 175.

A first passivation layer 180a including an inorganic insulator such as a silicon nitride or a silicon oxide is disposed on the data line 171 and the drain electrode 175.

An organic layer 80 is disposed on the first passivation layer 180a. In an exemplary embodiment, the organic layer 80 may be a color filter. When the organic layer 80 is a color filter, the organic layer 80 may uniquely display one of primary colors, and an example of the primary colors may include the three primary colors such as red, green, and blue, or yellow, cyan, and magenta, and the like.

When the organic layer 80 is the color filter, an overcoat may be additionally disposed on the color filter. The overcoat prevents components of the color filter from inflowing into an overlying pixel electrode or LC layer disposed thereon.

The first subpixel electrode 191a is disposed on the organic layer 80. The first subpixel electrode 191a has the planar shape and is provided throughout the entire pixel area. In an exemplary embodiment, the planar shape is not split.

In an exemplary embodiment, a second passivation layer 180b is disposed on the first subpixel electrode 191a. The second passivation layer 180b may include the inorganic insulator such as the silicon nitride or the silicon oxide.

The second subpixel electrode 191b is disposed on the second passivation layer 180b.

The second subpixel electrode 191b includes a crossed-shape stem (192 and 193) including a longitudinal stem 192 and a transverse stem 193 and a plurality of branch electrodes 194a to 194d extending from the stems 192 and 193 in four different directions.

The interval S between two adjacent branch electrodes among the plurality of branch electrodes 194a to 194d may be equal to or larger than a width W of the plurality of branch electrodes 194a to 194d. In an exemplary embodiment, the width W of the plurality of branch electrodes 194a to 194d may be about 2 μm to about 3 μm, and the interval S between two adjacent branch electrodes among the plurality of branch electrodes 194a to 194d may be about 3 μm to about 4 μm.

The plurality of branch electrodes 194a to 194d includes a plurality of first branch electrodes 194a extending from the stems 192 and 193 in an upper-left direction, a plurality of second branch electrodes 194b extending from the stems 192 and 193 in an upper-right direction, a plurality of third branch electrodes 194c extending from the stems 192 and 193 in a lower-left direction, and a plurality of branch electrodes 194d extending from the stems 192 and 193 in a lower-right direction. In this way, by providing a plurality of branch electrodes 194a to 194d extending in the different directions, the LC molecules are inclined in a direction parallel to length directions of the plurality of branch electrodes 194a to 194d by an influence of a fringe field generated at edges of the plurality of branch electrodes 194a to 194d. The plurality of branch electrodes 194a to 194d that extend in four different directions are provided in one pixel, and as a result, one pixel area includes four subareas in which the length directions of the plurality of branch electrodes are different from each other. Therefore, a direction in which LC molecules 31 are aligned in one pixel area is approximately four directions, and four domains in which alignment directions of the LC molecules 31 are different from each other are provided on the LC layer 3. As such, a reference viewing angle of the LCD may be increased by varying the tilt directions of the LC molecules.

In an exemplary embodiment, the pixel electrode 191 including the first subpixel electrode 191a and the second subpixel electrode 191b may include a transparent conductive material such as indium tin oxide (“ITO”) or indium zinc oxide (“IZO”).

The first subpixel electrode 191a and the second subpixel electrode 191b overlap each other with the second passivation layer 180b interposed therebetween.

The plurality of branch electrodes 194a to 194d of the second subpixel electrode 191b of the pixel electrode 191 overlap the first subpixel electrode 191a. Similarly, openings between the plurality of branch electrodes 194a to 194d of the second subpixel electrode 191b overlap the first subpixel electrode 191a.

A first contact hole 183 exposing a portion of the first subpixel electrode 191a is defined in the second passivation layer 180b. The second subpixel electrode 191b and the first subpixel electrode 191a are physically and electrically connected to each other through the first contact hole 183.

A second contact hole 185 exposing a portion of the drain electrode 175 is defined in the first passivation layer 180a and the organic layer 80, and the subpixel electrode 191a is electrically connected to the drain electrode 175 through the second contact hole 185, thereby receiving a data voltage from the drain electrode 175.

As described above, the second subpixel electrode 191b and the first subpixel electrode 191a are physically and electrically connected to each other through the first contact hole 183 such that the first subpixel electrode 191a and the second subpixel electrode 191b are applied with the voltage of the same magnitude.

In the case of the LCD according to the exemplary embodiment, the first subpixel electrode 191a is connected to the drain electrode 175 through the second contact hole 185, however according to the LCD according to another exemplary embodiment of the invention, the second subpixel electrode 191b may be connected to the drain electrode 175 through the second contact hole 185, or the first subpixel electrode 191a and the second subpixel electrode 191b may both be connected to the drain electrode 175 through the second contact hole 185. That is, at least one of the first subpixel electrode 191a and the second subpixel electrode 191b is connected to the drain electrode 175 through the second contact hole 185, and the first subpixel electrode 191a and the second subpixel electrode 191b are connected to each other through the first contact hole 183.

Next, the second display panel 200 will be described.

A light blocking member 220 and the common electrode 270 are disposed on a second substrate 210 including a transparent glass or plastic.

However, in a case of an LCD according to another exemplary embodiment of the invention, the light blocking member 220 may be disposed on the first display panel 100, and in a case of an LCD according to a further exemplary embodiment, the color filter disposed in the second display panel 200 may be included.

In an exemplary embodiment, alignment layers (not shown) may be disposed on inner surfaces of the display panels 100 and 200, and the alignment layers may be vertical alignment (“VA”) layers.

A polarizer (not shown) may be provided on the outer surface of the two display panels 100 and 200, and transmissive axes of the two polarizers may be orthogonal to each other and that either transmissive axis is parallel to the gate line 121. However, in another exemplary embodiment, the polarizer may only be disposed at one outer surface of the two display panels 100 and 200.

In an exemplary embodiment, the LC layer 3 has negative dielectric anisotropy, and the LC molecules 31 of the LC layer 3 may be aligned so that long axes thereof are perpendicular to the surface of the two display panels 100 and 200 in a state in which electric field is not generated. Therefore, the incident light does not pass through the crossed polarizers but is blocked in a state in which electric field is not generated.

In an exemplary embodiment, dielectric anisotropy Δ∈ of the LC layer 3 has a value of about −2.0 to about −2.7 at about 30° C.

In an exemplary embodiment, a thickness of the LC layer 3, that is, a cell gap representing an interval between the first display panel 100 and the second display panel 200 is about 2.6 μm to about 3 μm.

In an exemplary embodiment, the LC layer 3 may include a prepolymer such as a monomer hardened through a polymer reaction by a light. In an exemplary embodiment, the prepolymer may include a reactive mesogen polymerized by the light such as UV rays, for example. In an exemplary embodiment, a ratio of the prepolymer in the LC layer 3 may be about 0.1% to about 1.0%.

As described above, the pixel electrode 191 of the LCD according to an exemplary embodiment of the invention includes the first subpixel electrode 191a of the planar shape and the second subpixel electrode 191b including a plurality of branch electrodes, and the first subpixel electrode 191a and the second subpixel electrode 191b overlap each other. In this way, by providing the pixel electrode 191 to include the first subpixel electrode 191a of the planar shape and the second subpixel electrode 191b of a plurality of branch electrodes, and providing the first subpixel electrode 191a and the second subpixel electrode 191b to overlap each other, the transmittance of the LCD may be increased. In detail, in the region corresponding to the opening between the plurality of branch electrodes of the second subpixel electrode 191b, by generating the electric field between the first subpixel electrode 191a of the planar shape and the common electrode 270, a magnitude reduction of the electric field may also be prevented in the region where the cutouts for providing the plurality of branch electrodes are defined, thereby increasing the transmittance of the LCD.

In general, according to the LCD defining a plurality of openings therein, in a case that the cell interval of the LC layer 3 is decreased or an absolute value of the dielectric anisotropy Δ∈ is decreased, the transmittance of the LCD is deteriorated. However, in the case that the absolute value of the dielectric anisotropy Δ∈ of the LC layer 3 is decreased, viscosity between the LC molecules 31 of the LC layer 3 is decreased such that the response speed of the LC molecules 31 is increased.

According to the LCD according to an exemplary embodiment of the invention, by providing the pixel electrode 191 to include the first subpixel electrode 191a of the planar shape and the second subpixel electrode 191b of a plurality of branch electrodes, and providing the first subpixel electrode 191a and the second subpixel electrode 191b to overlap each other, the transmittance of the LCD is increased, and although the absolute value of the dielectric anisotropy Δ∈ of the LC layer 3 is decreased, the transmittance reduction of the LCD may be prevented. Accordingly, in the LCD according to an exemplary embodiment of the invention, without the transmittance deterioration of the LCD, the response speed of the LCD may be increased.

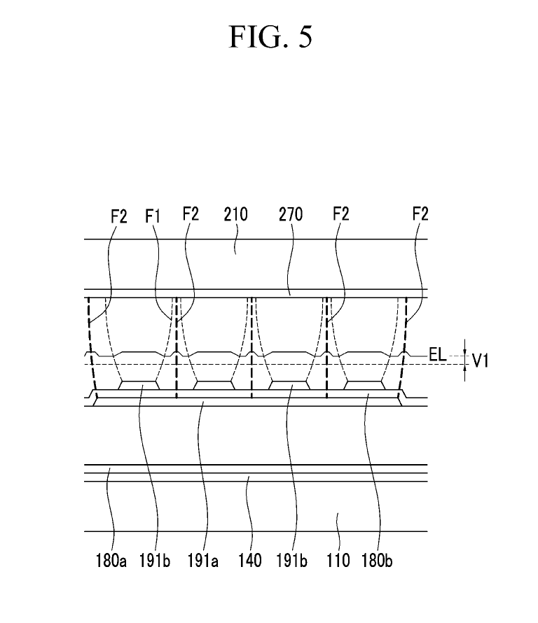

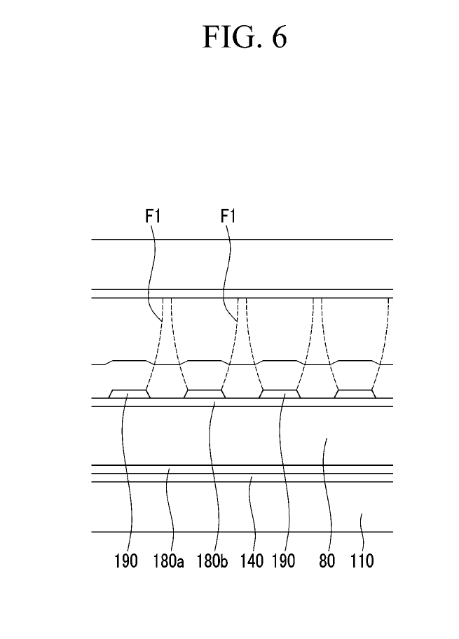

Next, one pixel area of the LCD according to an exemplary embodiment of the invention and a conventional LCD will be described with reference to FIGS. 5 and 6. FIG. 5 is a schematic view to explain a magnitude of an electric field applied to an LC layer of one pixel area of an LCD according to an exemplary embodiment of the invention, and FIG. 6 is a schematic view to explain a magnitude of an electric field applied to an LC layer of one pixel area of a conventional LCD.

Firstly, referring to FIG. 5, according to the LCD according to an exemplary embodiment of the invention, the second subpixel electrode 191b overlaps the first subpixel electrode 191a.

Accordingly, one pixel area includes a first region where the electric field is generated between the plurality of branch electrodes 194a to 194d of the second subpixel electrode 191b and the common electrode 270 and a second region where the electric field is generated between the first subpixel electrode 191a overlapping the opening between the plurality of branch electrodes 194a to 194d of the second subpixel electrode 191b and the common electrode 270.

According to the LCD according to an exemplary embodiment of the invention, along with the first electric field F1 generated between the second subpixel electrode 191b and the common electrode 270, by the second electric field F2 generated between the first subpixel electrode 191a overlapping the openings between the plurality of branch electrodes 194a, 194b, 194c, and 194d of the second subpixel electrode 191b and the common electrode 270, the LC molecules of the LC layer 3 are arranged.

In contrast, referring to FIG. 6, according to the conventional LCD, the pixel electrode 190 includes a plurality of branch electrodes and the pixel electrode of the planar shape is not provided.

Accordingly, in the conventional LCD, the LC molecules of the LC layer 3 are arranged only by the first electric field F1 generated between a plurality of branch electrodes of the pixel electrode 190 and the common electrode 270.

As shown in an equipotential line EL shown in FIGS. 5 and 6, intensity of the electric field applied to the LC layer of the LCD according to an exemplary embodiment of the invention is higher than the intensity of the electric field applied to the LC layer of the conventional LCD only including the pixel electrode having a plurality of branch electrodes.

In this way, in the region overlapping the openings between the plurality of branch electrodes, by the electric field generated between the subpixel electrode of the planar shape and the common electrode, an electric field intensity deterioration due to the opening formation may be prevented, thereby preventing the transmittance deterioration of the LCD.

Also, as described above, according to the LCD according to an exemplary embodiment of the invention, by providing the pixel electrode 191 to include the first subpixel electrode 191a of the planar shape and the second subpixel electrode 191b of a plurality of branch electrodes, and providing the first subpixel electrode 191a and the second subpixel electrode 191b to overlap each other, the transmittance of the LCD is increased, and although the absolute value of the dielectric anisotropy Δ∈ of the LC layer 3 is decreased, the transmittance reduction of the LCD may be prevented. Accordingly, in the LCD according to an exemplary embodiment of the invention, without the transmittance deterioration of the LCD, the response speed of the LCD may be increased.

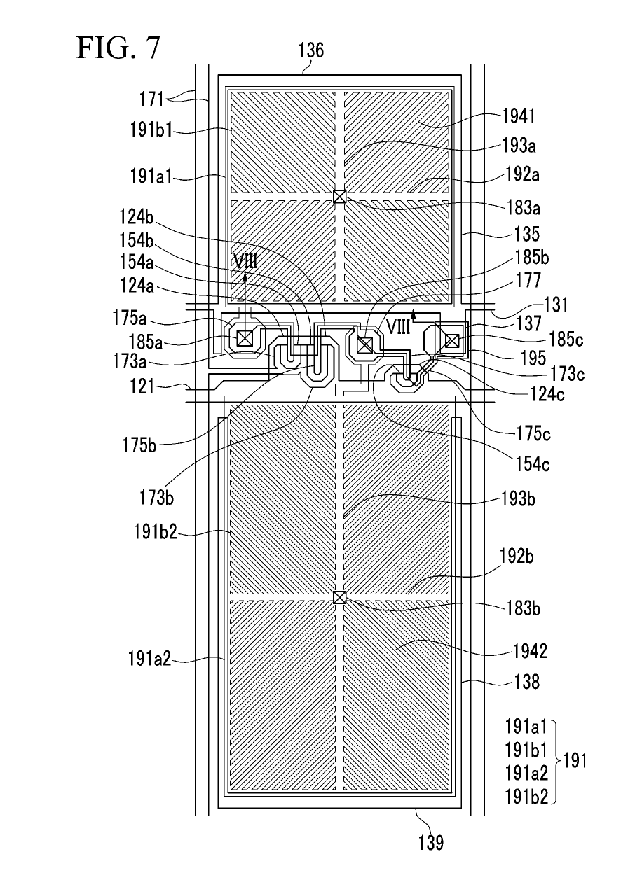

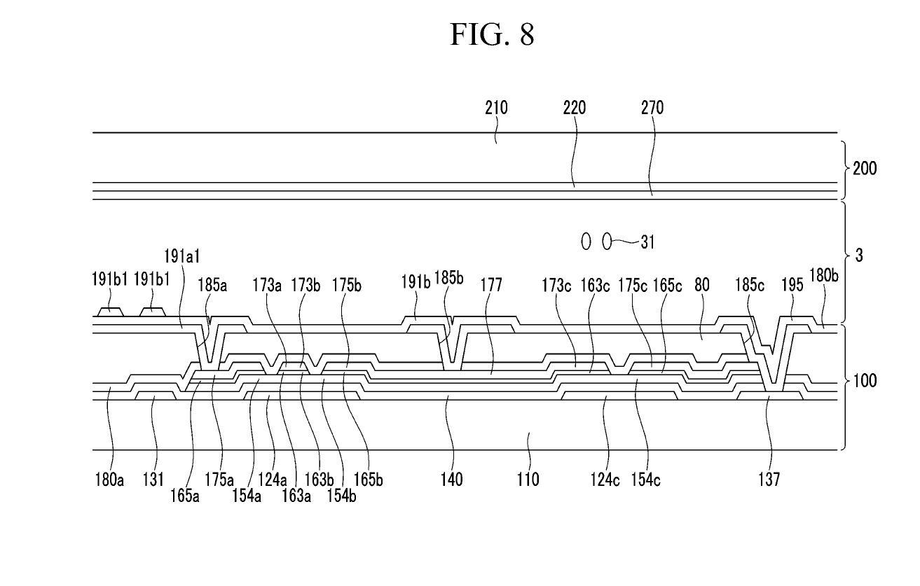

Next, an LCD according to another exemplary embodiment of the invention will be described with reference to FIGS. 7 and 8. FIG. 7 is a plan view of an LCD according to another exemplary embodiment of the invention, and FIG. 8 is a cross-sectional view of the LCD of FIG. 7 taken along line VIII-VIII.

Referring to FIGS. 7 and 8, an LCD according to an exemplary embodiment of the invention includes a first display panel 100 and a second display panel 200 facing each other, and an LC layer 3 inserted between the first display panel 100 and the second display panel 200.

Firstly, the first display panel 100 will be described.

A gate conductor including a gate line 121 and a divided voltage reference voltage line 131 is disposed on a first substrate 110 including transparent glass or plastic.

The gate line 121 includes a first gate electrode 124a, a second gate electrode 124b, and a third gate electrode 124c.

The divided voltage reference voltage line 131 includes first storage electrodes 135 and 136, and a reference electrode 137. Second storage electrodes 138 and 139 that are not connected to the divided voltage reference voltage line 131, but overlap a second subpixel electrode 191b, are also disposed.

A gate insulating layer 140 is disposed on the gate line 121 and the divided voltage reference voltage line 131.

A first semiconductor 154a, a second semiconductor 154b, and a third semiconductor 154c are disposed on the gate insulating layer 140.

A plurality of ohmic contacts 163a, 165a, 163b, 165b, 163c, and 165c is disposed on the semiconductors 154a, 154b, and 154c.

A data conductor including a plurality of data lines 171 including a first source electrode 173a, a second source electrode 173b, a first drain electrode 175a, a second drain electrode 175b, a third source electrode 173c, and a third drain electrode 175c is disposed on the ohmic contacts 163a, 165a, 163b, 165b, 163c, and 165c and the gate insulating layer 140.

In an exemplary embodiment, the data conductor, the semiconductor below the data conductor and ohmic contacts may be simultaneously provided by using one mask.

The first gate electrode 124a, the first source electrode 173a, and the first drain electrode 175a provide one first TFT together with the first semiconductor 154a, and a channel of the TFT is disposed on the first semiconductor 154a between the first source electrode 173a and the first drain electrode 175a. Likewise, the second gate electrode 124b, the second source electrode 173b, and the second drain electrode 175b provide one second TFT together with the second semiconductor 154b, and a channel is disposed on the second semiconductor 154b between the second source electrode 173b and the second drain electrode 175b, while the third gate electrode 124c, the third source electrode 173c, and the third drain electrode 175c provide one third TFT together with the third semiconductor 154c, and a channel is disposed on the third semiconductor 154c between the third source electrode 173c and the third drain electrode 175c.

The second drain electrode 175b is connected with the third source electrode 173c and includes an extension 177 which expands widely.

A first passivation layer 180a is disposed on the data conductors 171, 173c, 175a, 175b, and 175c and the exposed portion of the semiconductors 154a, 154b, and 154c. In an exemplary embodiment, the first passivation layer 180a may include an inorganic insulating layer such as a silicon nitride or a silicon oxide, for example. The first passivation layer 180a prevents a pigment of a color filter from flowing into the exposed portion of the semiconductors 154a, 154b, and 154c.

An organic layer 80 is disposed on the first passivation layer 180a. In an exemplary embodiment, the organic layer 80 may be the color filter.

When the organic layer 80 is the color filter, an overcoat may be further disposed on the organic layer 80. The overcoat prevents peeling of the color filter and suppresses contamination of the LC layer 3 by an organic material of the solvent that inflows from the color filter, so that it prevents defects such as afterimages that may occur when an image is driven.

A third subpixel electrode 191a1 and a fifth subpixel electrode 191a2 are disposed on the organic layer 80. The third subpixel electrode 191a1 is disposed at a first subpixel area, and the fifth subpixel electrode 191a2 is disposed at a second subpixel area. The first subpixel area and the second subpixel area provide one pixel area.

The third subpixel electrode 191a1 and the fifth subpixel electrode 191a2 have the planar shape throughout the entire first subpixel area and second subpixel area. The planar shape is not split.

The second passivation layer 180b is disposed on the third subpixel electrode 191a1 and the fifth subpixel electrode 191a2. In an exemplary embodiment, the second passivation layer 180b may include the inorganic insulator of a silicon nitride or a silicon oxide, for example.

The fourth subpixel electrode 191b1 and a sixth subpixel electrode 191b2 are disposed on the second passivation layer 180b.

The fourth subpixel electrode 191b1 includes the crossed-shape stem including a first longitudinal stem 192a and a first transverse stem 193a and a plurality of fifth branch electrodes 1941 extending from the stem. The interval S between two adjacent branch electrodes 1914 among the plurality of fifth branch electrodes 1941 may be equal to or larger than the width W of the plurality of fifth branch electrodes 1941. In an exemplary embodiment, the width W of the plurality of fifth branch electrodes 1941 may be about 2 μm to about 3 μm, and the interval S between two adjacent branch electrodes among the plurality of fifth branch electrodes 1941 may be about 3 μm to about 4 μm.

The sixth subpixel electrode 191b2 includes the crossed-shape stem including a second longitudinal stem 192b and a second transverse stem 193b, and a plurality of sixth branch electrodes 1942 extending from the stem. The interval S between two adjacent branch electrodes 1942 among a plurality of sixth branch electrodes 1942 may be equal to or larger than a width of the plurality of sixth branch electrodes 1942. In an exemplary embodiment, the width W of the plurality of sixth branch electrodes 1942 may be about 2 μm to about 3 μm, and the interval S between two adjacent branch electrodes among the plurality of sixth branch electrodes 1942 may be about 3 μm to about 4 μm.

The third subpixel electrode 191a1 and the fourth subpixel electrode 191b1 overlap each other with the second passivation layer 180b interposed therebetween, and the fifth subpixel electrode 191a2 and the sixth subpixel electrode 191b2 overlap each other with the second passivation layer 180b interposed therebetween.

A third contact hole 183a exposing a portion of the third subpixel electrode 191a1 is defined in the second passivation layer 180b. The third subpixel electrode 191a1 and the fourth subpixel electrode 191b1 are physically and electrically connected to each other through the third contact hole 183a.

A fourth contact hole 183b exposing a portion of the fifth subpixel electrode 191a2 is defined in the second passivation layer 180b. The fifth subpixel electrode 191a2 and the sixth subpixel electrode 191b2 are physically and electrically connected to each other through the fourth contact hole 183b.

A fifth contact hole 185a and a sixth contact hole 185b exposing the first drain electrode 175a and the second drain electrode 175b, respectively, are defined in the first passivation layer 180a and the organic layer 80.

A seventh contact hole 185c exposing a portion of the reference electrode 137 and a portion of the third drain electrode 175c is defined in the first passivation layer 180a, the organic layer 80, and the gate insulating layer 140, and the seventh contact hole 185c covers a connecting member 195. The connecting member 195 electrically connects the reference electrode 137 and the third drain electrode 175c exposed through the seventh contact hole 185c.

As described above, the third subpixel electrode 191a1 and the fourth subpixel electrode 191b1 are physically and electrically connected to each other through the third contact hole 183a such that the third subpixel electrode 191a1 and the fourth subpixel electrode 191b1 are applied with the voltage of the same magnitude.

Also, through the fourth contact hole 183b, the fifth subpixel electrode 191a2 and the sixth subpixel electrode 191b2 are physically and electrically connected to each other such that the fifth subpixel electrode 191a2 and the sixth subpixel electrode 191b2 are applied with the voltage of the same magnitude.

The fourth contact hole 183b exposing a portion of the fourth subpixel electrode 191b1 is defined in the second passivation layer 180b. Through the fourth contact hole 183b, the fifth subpixel electrode 191a2 and the sixth subpixel electrode 191b2 are physically and electrically connected to each other.

Next, the second display panel 200 will be described.

A light blocking member 220 and a common electrode 270 are disposed on a second substrate 210 including transparent glass or plastic.

However, in a case of an LCD according to another exemplary embodiment of the invention, the light blocking member 220 may be positioned on the first display panel 100, and in a case of an LCD according to a further exemplary embodiment, the color filter positioned in the second display panel 200 may be included.

In an exemplary embodiment, alignment layers (not shown) may be disposed on inner surfaces of the display panels 100 and 200, and the alignment layers may be VA layers.

In an exemplary embodiment, a polarizer (not shown) may be provided on the outer surface of the two display panels 100 and 200, and it is preferable for transmissive axes of the two polarizers to be orthogonal to each other and that either one transmissive axis of them is parallel to the gate line 121. However, in another exemplary embodiment, the polarizer may only be disposed at one outer surface of the two display panels 100 and 200.

In an exemplary embodiment, the LC layer 3 has negative dielectric anisotropy, and the LC molecules of the LC layer 3 may be aligned so that long axes thereof are perpendicular to the surface of the two display panels 100 and 200 in a state in which electric field is not generated. Therefore, the incident light does not pass through the crossed polarizers but is blocked in a state in which electric field is not generated. In an exemplary embodiment, dielectric anisotropy Δ∈ of the LC layer 3 has a value of about −2.0 to about −2.7 at about 30° C.

In an exemplary embodiment, a thickness of the LC layer 3, that is, a cell gap representing an interval between the first display panel 100 and the second display panel 200 is about 2.6 μm to about 3 μm.

In an exemplary embodiment, the LC layer 3 may include a prepolymer such as a monomer that is hardened through a polymer reaction by a light. In an exemplary embodiment, the prepolymer may include a reactive mesogen polymerized by the light such as UV rays, for example. In an exemplary embodiment, a ratio of the prepolymer in the LC layer 3 may be about 0.1% to about 1.0%.

Next, a driving method of the LCD according to the exemplary embodiment will be described.

When a gate-on signal is applied to the gate line 121, the first switching element, the second switching element, and the third switching element that are connected thereto are turned on. Accordingly, the data voltage applied to the data line is respectively applied to the third subpixel electrode 191a1 and the fourth subpixel electrode 191b1, and the fifth subpixel electrode 191a2 and the sixth subpixel electrode 191b2a through the first switching element and the second switching element that are turned on. At this time, the data voltages applied to the third subpixel electrode 191a1 and the fourth subpixel electrode 191b1 are the same, and the fifth subpixel electrode 191a2 and the sixth subpixel electrode 191b2 are the same. Simultaneously, the fifth subpixel electrode 191a2 and the sixth subpixel electrode 191b2 is divided through the turned-on third switching element. Accordingly, the voltage charged to the fifth subpixel electrode 191a2 and the sixth subpixel electrode 191b2 is decreased by a difference between the common voltage and the divided reference voltage. That is, the voltage charged to the third subpixel electrode 191a1 and the fourth subpixel electrode 191b1 is higher than the voltage charged to the fifth subpixel electrode 191a2 and the sixth subpixel electrode 191b2. The third subpixel electrode 191a1 and the fourth subpixel electrode 191b1 and the common electrode 270 provide two terminals of the first LC capacitor, and the fifth subpixel electrode 191a2 and the sixth subpixel electrode 191b2 and the common electrode 270 provide two terminals of the second LC capacitor.

Resultantly, the voltage charged to the first subpixel area and the voltage charged to the second subpixel area are different from each other. Accordingly, an inclination angle of the LC molecules in the first subpixel area and the inclination angle of the LC molecules in the second subpixel area are different from each other, thereby differentiating the luminance of the two subpixel areas. Therefore, when the voltage charged to the third subpixel electrode 191a1 and the fourth subpixel electrode 191b1 and the voltage charged to the fifth subpixel electrode 191a2 and the sixth subpixel electrode 191b2 are appropriately adjusted, it is possible to make an image viewed from the side be as similar as possible to an image viewed from the front, and as a result, it is possible to improve the side visibility

In the shown exemplary embodiment, to differentiate the voltage charged to the third subpixel electrode 191a1 and fourth subpixel electrode 191b1 and the voltage charged to the fifth subpixel electrode 191a2 and the sixth subpixel electrode 191b2, the third switching element is connected to the output terminal of the second switching element and the divided voltage reference line, however, in a case of the LCD according to another exemplary embodiment of the invention, the second switching element may be connected to a step-down capacitor. Specifically, the voltage charged in the first LC capacitor and the voltage charged in the second LC capacitor may be differently set by including the third switching element including a first terminal connected to a step-down gate line, a second terminal connected to the second LC capacitor, and a third terminal connected to the step-down capacitor, and charging a part of charge amounts charged in the second LC capacitor to the step-down capacitor. Further, in an LCD according to another exemplary embodiment of the invention, the voltage charged in the first LC capacitor and the voltage charged in the second LC capacitor may be differently set by connecting the first LC capacitor and the second LC capacitor to different data lines to receive different data voltages. In addition, the voltage charged in the first LC capacitor and the voltage charged in the second LC capacitor may be differently set through various other methods.

According to the LCD according to an exemplary embodiment of the invention, the pixel electrode 191 includes the third subpixel electrode 191a1 and the fifth subpixel electrode 191a2 of the planar shape and the fourth subpixel electrode 191b1 and the sixth subpixel electrode 191b2 including a plurality of branch electrodes, the third subpixel electrode 191a1 and the fourth subpixel electrode 191b1 overlap each other, and the fourth subpixel electrode 191b1 and the sixth subpixel electrode 191b2 overlap each other.

In this way, by providing the pixel electrode 191 including the third subpixel electrode 191a1 and the fifth subpixel electrode 191a2 of the planar shape, and the fourth subpixel electrode 191b1 and the sixth subpixel electrode 191b2 including a plurality of branch electrodes, the transmittance of the LCD may be increased. In detail, in the region corresponding to the openings between the plurality of branch electrodes of the fourth subpixel electrode 191b1 and the sixth subpixel electrode 191b2, by generating the electric field between the third subpixel electrode 191a1 and the fifth subpixel electrode 191a2, and the common electrode 270, the magnitude reduction of the electric field may also be prevented in the region where the cutouts to provide a plurality of branch electrodes are defined, thereby increasing the transmittance of the LCD.

In general, according to the LCD defining a plurality of openings therein, in a case that the cell interval of the LC layer 3 is decreased or an absolute value of the dielectric anisotropy Δ∈ is decreased, the transmittance of the LCD is deteriorated. However, in the case that the absolute value of the dielectric anisotropy Δ∈ of the LC layer 3 is decreased, viscosity between the LC molecules 31 of the LC layer 3 is decreased such that the response speed of the LC molecules 31 is increased.

According to the LCD according to an exemplary embodiment of the invention, by providing the pixel electrode 191 to include the third subpixel electrode 191a1 and the fifth subpixel electrode 191a2 of the planar shape, the fourth subpixel electrode 191b1 and the sixth subpixel electrode 191b2 including a plurality of branch electrodes, the third subpixel electrode 191a1 and the fourth subpixel electrode 191b1 to be overlapped, and the fifth subpixel electrode 191a2 and the sixth subpixel electrode 191b2 to be overlapped, transmittance of the LCD is increased, and although the absolute value of the dielectric anisotropy Δ∈ of the LC layer 3 is decreased, the transmittance reduction of the LCD may be prevented. Accordingly, in the LCD according to an exemplary embodiment of the invention, without the transmittance deterioration of the LCD, the response speed of the LCD may be increased.

Next, an experimental example of the invention will be described with reference to Tables 1 to 3.

In the experimental example, while changing the width W of a plurality of branch electrodes of the pixel electrode and the interval S between two adjacent branch electrodes, the cell gap of the LC layer 3, the dielectric anisotropy Δ∈ of the LC layer 3, and a rotation viscosity γ1 of the LC layer 3, like the conventional LCD, compared with a case of defining a plurality of cutouts which separates a plurality of branch electrodes in the pixel electrode, like the LCD according to an exemplary embodiment of the invention, when providing the pixel electrode including the first subpixel electrode of the planar shape and the second subpixel electrode overlapping the first subpixel electrode via an insulating layer and including a plurality of branch electrodes and applying the same voltage to the first subpixel electrode and the second subpixel electrode, a ratio of the transmittance and the response time is measured.

Values of the width W of a plurality of branch electrodes of the pixel electrode and the interval S between two adjacent branch electrodes, the cell gap of the LC layer 3, the dielectric anisotropy Δ∈ of the LC layer 3, and the rotation viscosity γ1 of the LC layer 3 are represented in Tables 1 to 3, a case 1 and a case 2 in Tables 1 to 3 are results comparing the transmittance, and a case 3 and a case 4 are results comparing the response time. Each result represents the ratio of the values of the LCD according to an exemplary embodiment of the invention for the values of the conventional LCD by a percentage. In Tables 1 to 3, Ton is the response time when the LCD is changed from an off state to an on state, and Toff is the response time when the LCD is changed from the on state to the off state.

TABLE 1

| | Cell | | | | Case 2 [%] | Case 3 | | Case 4 | |
|---|---|---|---|---|---|---|---|---|---|
| W/S | gap | Δ∈ | γ1 | Case 1 [%] | Ton [%] | | Toff [%] | Ton[%] | Toff [%] |
| 3 μm/ | 3.0 μm | −2.7 | 71 | 103.3 | 103.8 | 22.9 | 102.5 | 29.2 | 102.3 |
| 3 μm | 2.8 μm | −2.7 | 71 | 104.0 | 105.3 | 20.0 | 88.5 | 36.1 | 89.1 |
| | 2.6 μm | −2.7 | 71 | 103.8 | 105.0 | 19.3 | 76.1 | 43.6 | 76.6 |
| 2 μm/ | 3.0 μm | −2.7 | 71 | 103.3 | 103.8 | 22.0 | 103.1 | 22.0 | 103.0 |
| 4 μm | 2.8 μm | −2.7 | 71 | 104.0 | 105.3 | 18.6 | 89.0 | 21.7 | 89.8 |
| | 2.6 μm | −2.7 | 71 | 103.8 | 105.1 | 16.6 | 76.6 | 29.8 | 77.2 |

In Table 1, the dielectric anisotropy Δ∈ of the LC layer 3 is about −2.7 at about 30° C., the rotation viscosity γ1 of the LC layer 3 is about 71, the width W of the plurality of branch electrodes of the pixel electrode and the interval S between two adjacent branch electrodes are respectively about 3 μm and about 3 μm, and about 2 μm and about 4 μm, when changing the cell interval to about 3.0 μm, about 2.8 μm, and about 2.6 μm, the transmittance and the response time are measured.

Referring to Table 1, compared with a case of providing the conventional pixel electrode including a plurality of branch electrodes, the ratio of the transmittance is larger than 100%. Accordingly, in the LCD according to an exemplary embodiment of the invention, it may be confirmed that the transmittance of the LCD is increased. Also, in the case (the case 3, the case 4) of the response time, the response time Ton when the LCD is changed from the off state to the on state is only about 17% of the value of the conventional LCD, and the response speed Toff when the LCD is changed from the on state to the off state is only about 77% of the value of the conventional LCD. That is, it may be confirmed that the response time of the LCD according to an exemplary embodiment of the invention is shorter than the response time of the conventional LCD.

In this way, in the case of the LCD according to an exemplary embodiment of the invention, the transmittance of the LCD is increased and the response time of the LCD is decreased such that it may be confirmed that the response speed is increased.

TABLE 2

| | Cell | | | | Case 2 [%] | Case 3 | | Case 4 | |
|---|---|---|---|---|---|---|---|---|---|
| W/S | gap | Δ∈ | γ1 | Case 1 [%] | Ton [%] | | Toff [%] | Ton [%] | Toff [%] |
| 3 μm/ | 3.0 μm | −2.7 | 71 | 103.3 | 103.8 | 22.9 | 102.5 | 29.2 | 102.3 |
| 3 μm | 2.8 μm | −2.7 | 71 | 104.0 | 105.3 | 20.0 | 88.5 | 36.1 | 89.1 |
| | 2.6 μm | −2.7 | 71 | 103.8 | 105.0 | 19.3 | 76.1 | 43.6 | 76.6 |
| 2 μm/ | 3.0 μm | −2.7 | 71 | 103.3 | 103.8 | 22.0 | 103.1 | 22.0 | 103.0 |
| 4 μm | 2.8 μm | −2.7 | 71 | 104.0 | 105.3 | 18.6 | 89.0 | 21.7 | 89.8 |
| | 2.6 μm | −2.7 | 71 | 103.8 | 105.1 | 16.6 | 76.6 | 29.8 | 77.2 |

In Table 2, the dielectric anisotropy Δ∈ of the LC layer 3 is about −2.3 at about 30° C., the rotation viscosity γ1 of the LC layer 3 is about 59, the width W of a plurality of branch electrodes of the pixel electrode and the interval S between two adjacent branch electrodes are respectively about 3 μm and about 3 μm, and about 2 μm and about 4 μm, and when changing the cell interval to about 3.0 μm, about 2.8 μm, and about 2.6 μm, the transmittance and the response time are measured.

Referring to Table 2, compared with a case of providing the conventional pixel electrode including a plurality of branch electrodes, the ratio of the transmittance is larger than 100%. Accordingly, in the LCD according to an exemplary embodiment of the invention, it may be confirmed that the transmittance of the LCD is increased. Also, in the case (the case 3, the case 4) of the response time, the response time Ton when the LCD is changed from the off state to the on state is only about 17% of the value of the conventional LCD, and the response speed Toff when the LCD is changed from the on state to the off state is only about 63% of the value of the conventional LCD. That is, it may be confirmed that the response time of the LCD according to an exemplary embodiment of the invention is shorter than the response time of the conventional LCD.

In this way, in the case of the LCD according to an exemplary embodiment of the invention, the transmittance of the LCD is increased and the response time of the LCD is decreased such that it may be confirmed that the response speed is increased.

TABLE 3

| | Cell | | | | Case 2 [%] | Case 3 | | Case 4 | |
|---|---|---|---|---|---|---|---|---|---|
| W/S | gap | Δ∈ | γ1 | Case 1 [%] | Ton [%] | | Toff [%] | Ton [%] | Toff [%] |
| 3 μm/ | 3.0 μm | −2.0 | 53 | 101.5 | 99.3 | 25.9 | 73.6 | 29.3 | 72.6 |
| 3 μm | 2.8 μm | −2.0 | 53 | 102.8 | 101.4 | 23.0 | 63.8 | 33.4 | 63.5 |
| | 2.6 μm | −2.0 | 53 | 102.5 | 101.0 | 22.6 | 54.9 | 39.0 | 54.6 |
| 2 μm/ | 3.0 μm | −2.0 | 53 | 101.5 | 99.3 | 24.8 | 74.1 | 25.2 | 73.1 |
| 4 μm | 2.8 μm | −2.0 | 53 | 102.8 | 101.5 | 21.2 | 64.3 | 24.7 | 64.0 |
| | 2.6 μm | −2.0 | 53 | 102.5 | 101.1 | 19.1 | 55.3 | 29.4 | 55.0 |

In Table 3, the dielectric anisotropy Δ∈ of the LC layer 3 is about −2.0 at about 30° C., the rotation viscosity γ1 of the LC layer 3 is about 53, the width W of a plurality of branch electrodes of the pixel electrode and the interval S between two adjacent branch electrodes are respectively about 3 μm and about 3 μm, and about 2 μm and about 4 μm, and when changing the cell interval to about 3.0 μm, about 2.8 μm, and about 2.6 μm, the transmittance and the response time are measured.

Referring to Table 3, compared with a case of providing the conventional pixel electrode including a plurality of branch electrodes, the ratio of the transmittance is mainly larger than 100%. Accordingly, in the LCD according to an exemplary embodiment of the invention, it may be confirmed that the transmittance of the LCD is increased. Also, in the case (the case 3, the case 4) of the response time, the response time Ton when the LCD is changed from the off state to the on state is only about 17% of the value of the conventional LCD, and the response speed Toff when the LCD is changed from the on state to the off state is only about 55% of the value of the conventional LCD. That is, it may be confirmed that the response time of the LCD according to an exemplary embodiment of the invention is shorter than the response time of the conventional LCD.

In this way, in the case of the LCD according to an exemplary embodiment of the invention, the transmittance of the LCD is increased and the response time of the LCD is decreased such that it may be confirmed that the response speed is increased.

Referring to Tables 1 to 3, like the LCD according to an exemplary embodiment of the invention, when the width W of a plurality of branch electrodes is about 2 μm to about 3 μm, the interval S between two adjacent branch electrodes among the plurality of branch electrodes is about 3 μm to about 4 μm, the cell gap of the LC layer 3 is about 2.6 μm to about 3 μm, and the dielectric anisotropy Δ∈ of the LC layer 3 has a value of about −2.0 to about −2.7 at about 30° C., compared with the conventional pixel electrode including a plurality of branch electrodes, the ratio of the transmittance is mainly more than 100%. Accordingly, in the LCD according to an exemplary embodiment of the invention, the transmittance of the LCD may be increased. That is, according to the LCD according to an exemplary embodiment of the invention, when the interval S between two adjacent branch electrodes among the plurality of branch electrodes is larger than or almost equal to the width W of the plurality of branch electrodes, it may be confirmed that the transmittance is also increased compared with the conventional LCD. Also, when the absolute value of the dielectric anisotropy of the LCD is decreased, it may be confirmed that the transmittance is also increased compared with the conventional LCD.

Further, in the case of the ratio of the response time, the response time Ton when the LCD is changed from the off state to the on state is about 17% of the value of the conventional LCD, and in the case of the response speed Toff when the LCD is changed from the on state to the off state, it may be confirmed that the absolute value of the dielectric anisotropy of the LCD is decreased and is smaller than the value of the conventional LCD. That is, the response time of the LCD according to an exemplary embodiment of the invention is shorter than the response time of the conventional LCD.

As described above, in the case of the LCD according to an exemplary embodiment of the invention, it may be conformed that the transmittance of the LCD is increased, and the response time of the LCD is shortened such that the response speed is increased.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A liquid crystal display comprising:
a first substrate;
a first subpixel electrode which is disposed on the first substrate and has a planar shape and;
an insulating layer disposed on the first subpixel electrode;
a second subpixel electrode which is disposed on the insulating layer, overlaps the first subpixel electrode, and includes a plurality of branch electrodes;
a second substrate facing the first substrate;
a common electrode disposed on the second substrate; and
a liquid crystal layer between the first substrate and the second substrate,
wherein
the first subpixel electrode and the second subpixel electrode are applied with voltages of the same magnitude, and
dielectric anisotropy of the liquid crystal layer is about −2.0 to about −2.7 at a temperature of about 30 degrees Celsius.

2. The liquid crystal display of claim 1, wherein
an interval between two adjacent branch electrodes among the plurality of branch electrodes is equal to or greater than a width of a branch electrode of the plurality of branch electrodes.

3. The liquid crystal display of claim 2, wherein
the width of the branch electrode of the plurality of branch electrodes is about 2 micrometers to about 3 micrometers, and
the interval between the two adjacent branch electrodes among the plurality of branch electrodes is about 3 micrometers to about 4 micrometers.

4. The liquid crystal display of claim 3, wherein
a cell interval of the liquid crystal layer is about 2.6 micrometers to about 3 micrometers.

5. The liquid crystal display of claim 1, wherein
a width of a branch electrode of the plurality of branch electrodes is about 2 micrometers to about 3 micrometers, and
an interval between two adjacent branch electrodes among the plurality of branch electrodes is about 3 micrometers to about 4 micrometers.

6. The liquid crystal display of claim 5, wherein
a cell interval of the liquid crystal layer is about 2.6 micrometers to about 3 micrometers.

7. The liquid crystal display of claim 1, wherein
a cell interval of the liquid crystal layer is about 2.6 micrometers to about 3 micrometers.

8. The liquid crystal display of claim 1, wherein
the first subpixel electrode and the second subpixel electrode are connected to each other through a contact hole defined in the insulating layer.

9. The liquid crystal display of claim 1, further comprising:
a gate line and a data line disposed on the first substrate; and
a thin film transistor which is connected to the gate line and the data line and includes a drain electrode,
wherein at least one of the first subpixel electrode and the second subpixel electrode is connected to the drain electrode of the thin film transistor.

10. A liquid crystal display comprising:
a first substrate;
a first subpixel electrode disposed on the first substrate;
an insulating layer disposed on the first subpixel electrode;
a second subpixel electrode disposed on the insulating layer and overlapping the first subpixel electrode;
a second substrate facing the first substrate;
a common electrode disposed on the second substrate; and
a liquid crystal layer between the first substrate and the second substrate,
wherein
the first subpixel electrode and the second subpixel electrode are applied with voltages of the same magnitude,
the second subpixel electrode includes a plurality of branch electrodes,
the first subpixel electrode has a planar shape, and
an interval between two adjacent branch electrodes among the plurality of branch electrodes is equal to or greater than a width of a branch electrode of the plurality of branch electrodes.

11. The liquid crystal display of claim 10, wherein
the width of the branch electrode of the plurality of branch electrodes is about 2 micrometers to about 3 micrometers, and
the interval between the two adjacent branch electrodes among the plurality of branch electrodes is about 3 micrometers to about 4 micrometers.

12. The liquid crystal display of claim 11, wherein
a cell interval of the liquid crystal layer is about 2.6 micrometers to about 3 micrometers.

13. The liquid crystal display of claim 10, wherein
a cell interval of the liquid crystal layer is about 2.6 micrometers to about 3 micrometers.

14. A liquid crystal display comprising:
a first substrate;
a first subpixel electrode disposed on the first substrate;
an insulating layer disposed on the first subpixel electrode;
a second subpixel electrode disposed on the insulating layer and overlapping the first subpixel electrode;
a second substrate facing the first substrate;
a common electrode disposed on the second substrate; and
a liquid crystal layer between the first substrate and the second substrate,
wherein
the first subpixel electrode and the second subpixel electrode are applied with voltages of the same magnitude,
the second subpixel electrode includes a plurality of branch electrodes, the first subpixel electrode has a planar shape, and
a cell interval of the liquid crystal layer is about 2.6 micrometers to about 3 micrometers.
